(19) United States
(12) Patent Application Publication
(10) Pub. No.: US 2017/0254026 A1
(43) Pub. Date: Sep. 7, 2017

(54) PAVER EDGE RESTRAINT SYSTEM AND METHOD

(71) Applicant: Wausau Tile, Inc., Wausau, WI (US)

(72) Inventors: Rene Dupuis, Waunakee, WI (US); Joe Conrad, Wausau, WI (US); Rodney Dombrowski, Weston, WI (US)

(21) Appl. No.: 15/446,723

(22) Filed: Mar. 1, 2017

Related U.S. Application Data
(60) Provisional application No. 62/302,098, filed on Mar. 1, 2016.

(51) Int. Cl. E01C 5/00; F16M 13/02

(52) U.S. Cl. CPC E01C 5/005; E01C 5/00; F16M 13/02; E01C 5/06

(57) ABSTRACT

A paver edge restraint system for supporting a paver adjacent to an upstanding wall is provided, wherein the paver has a top surface and a bottom surface, and wherein the paver edge restraint system includes a support bracket including a first member extending in a first direction and a second member extending in a second direction, the first direction being parallel to the bottom surface of the paver, and the second direction being parallel to the upstanding wall. The first member can be configured to support the paver, and the second member can be configured to be coupled to the upstanding wall. A restraining bracket can extend beneath the paver and be positioned to limit upward movement of the paver.

### CROSS-REFERENCE TO RELATED APPLICATIONS

This application claims priority to U.S. Provisional Application No. 62/302,098, filed Mar. 1, 2016, the entire contents of which are incorporated by reference herein.

### BACKGROUND

The present invention relates to paver or roof tile systems, and particularly to paver or roof tile edge restraint systems.

### SUMMARY

Some embodiments of the present disclosure provide a paver edge restraint system for supporting a paver adjacent to an upstanding wall, wherein the paver has a top surface and a bottom surface, and wherein the paver edge restraint system comprises a support bracket including a first member extending in a first direction and a second member extending in a second direction, the first direction being parallel to the bottom surface of the paver, the second direction being parallel to the upstanding wall, the first member configured to support the paver, the second member configured to be coupled to the upstanding wall; and a restraining bracket extending beneath the paver and positioned to limit upward movement of the paver.

In some embodiments, a paver edge restraint system for securing a paver in an elevated position adjacent a wall and with respect to a surface beneath the paver is provided, wherein the paver is supported upon the surface by at least one pedestal disposed a distance from the wall, and wherein the paver edge restraint system comprises a support bracket configured to be mounted to a side of the wall, the support bracket having an elongated horizontal surface extending from the wall and positioned to support an edge of the paver adjacent the wall; a restraining bracket; and at least one fastener positioned to mount the restraining bracket to an underside of the paver; and wherein a portion of the support bracket is positioned to extend over a portion of the restraining bracket to restrict vertical movement of the restraining bracket and the paver thereon.

Some embodiments of the present disclosure provide a method of securing a paver in elevated position with respect to an underlying surface and an adjacent wall, wherein the method comprises orienting a support bracket in a substantially horizontal orientation against the side of the wall at an elevation above the underlying surface; mounting the support bracket to the side of the wall in the substantially horizontal orientation and at the elevation; mounting a restraining bracket to an underside of the paver; positioning a first edge of the paver on a pedestal located a distance from the wall; positioning a second edge of the paver on a portion of the support bracket extending away from the wall; supporting the first edge of the paver upon the pedestal; supporting the second edge of the paver upon the portion of the support bracket so that the paver is elevated over the surface; restricting upward movement of the restraining bracket with the support bracket; and restricting upward movement of the paver by restricting upward movement of the restraining bracket.

Other aspects of the invention will become apparent by consideration of the detailed description and accompanying drawings.

### BRIEF DESCRIPTION OF THE DRAWINGS

FIG. 1 is a schematic diagram of a plurality of pavers arranged in a pattern according to one embodiment of the present disclosure.

FIG. 2 is a cross-sectional view of an edge restraint system according to one embodiment.

FIG. 3 is another cross-sectional view of the edge restraint system of FIG. 2, taken along lines 3-3 of FIG. 2.

FIG. 4 is a perspective view of a support bracket according to the embodiment of FIG. 2.

FIG. 5 is a perspective view of a restraining bracket according to the embodiment of FIG. 2.

FIG. 6 is a cross-sectional view of an edge restraint system according to another embodiment.

FIG. 7 is a cross-sectional view of an edge restraint system according to another embodiment.

FIG. 8 is a cross-sectional view of an edge restraint system according to another embodiment.

FIG. 9 is a top view of the support bracket used in the embodiment of FIG. 1.

FIG. 10 is a bottom view of the support bracket shown in FIG. 9.

FIG. 11 is an end view of the support bracket shown in FIG. 9.

FIG. 12 is a top view of a restraining bracket used in the embodiment of FIG. 1.

FIG. 13 is an end view of the restraining bracket shown in FIG. 12.

FIG. 14 is a cross-sectional view of the edge restraint system shown in FIG. 1.

FIG. 15 is one embodiment of a fastener for use in the edge restraint system of FIG. 1.

FIG. 16 is another embodiment of a fastener for use in the edge restraint system of FIG. 1.

### DETAILED DESCRIPTION

Before embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

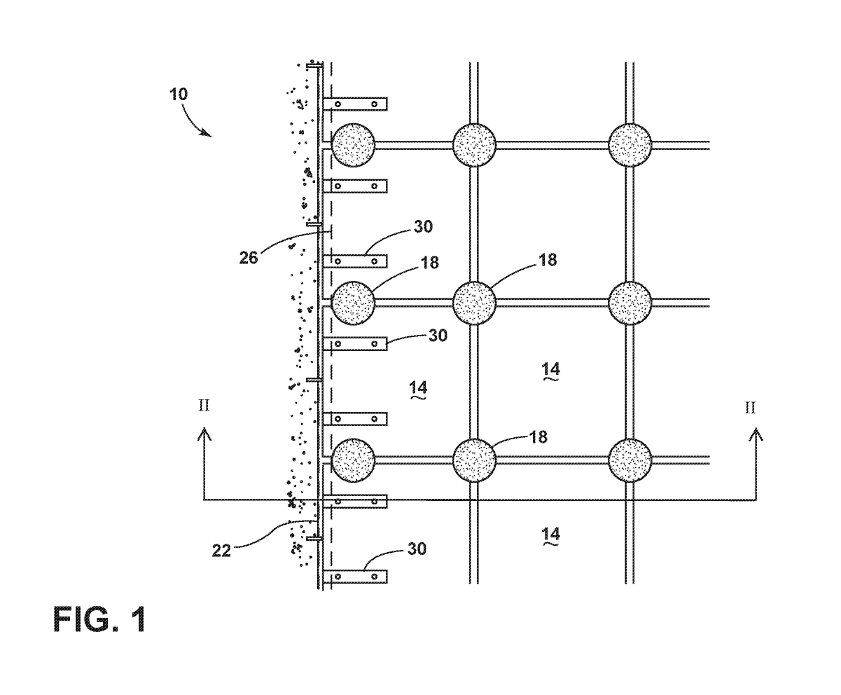

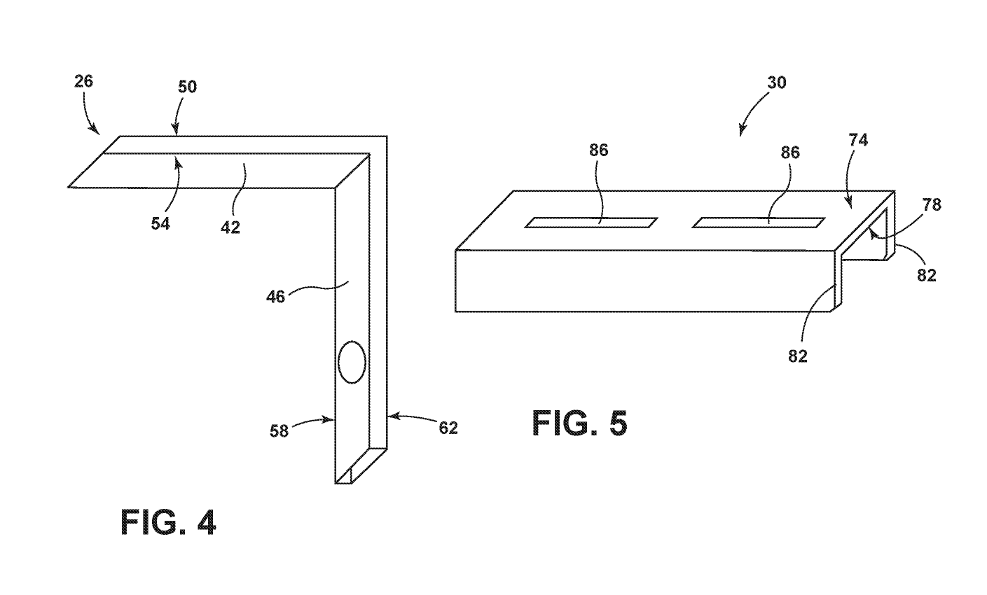

FIGS. 1-5 illustrate an edge restraint system 10 for use with tiles or pavers 14 (referred to herein simply as “pavers”) on a roof or other surface. As used herein, the term “paver” includes any platform, slab, tile, plate, or other similar element that is typically flat and/or planar, and that can be assembled in patterned (e.g., rows, grids, and the like) or patternless groups to define an extended surface over at least a portion of a roof or other surface, regardless of whether the extended surface is intended to support human or animal traffic, and regardless of whether the extended surface is capable of supporting a load (other than that defined by the pavers 14 and pedestals). Pavers 14 are not limited to any particular materials, and can be composed of concrete, plastic, granite and other stone, wood, ceramic, glass, metal, terrazzo, asphalt, and any combination of such materials, by way of example only.

Often times, pedestals 18 are utilized to support and/or restrain pavers 14 above a roof or other surface. For example, pedestals 18 can be used to support patios, terraces, parking garage surfaces, or plazas. Pedestals 10 can be installed on surfaces other than roofs where it is desirable to elevate the height of the pavers 14 with respect to an underlying structure or substrate. Pedestals 10 can also be installed beneath pavers 14 to anchor the pavers 14 to the underlying surface and restrain them from lifting up, such as from wind lift experienced on rooftops. Accordingly, the illustrated paver system 10 is particularly well-suited to support pavers 14 located in places experiencing high winds and/or seismic conditions.

Pavers 14 are typically arranged in groups or rows that create an array or pattern of pavers 14. A plurality of pavers 14 arranged in a pattern is referred to herein as a paver 14 arrangement. A pedestal 18 can be positioned at one or more of the corner or edge of each paver 14 where two or more pavers 14 meet. For example, a pedestal 18 may be positioned between two pavers 14 where the edge of one paver 14 meets the edge of another paver 14. A paver 14 may be positioned at the juncture of four pavers 14 where paver corners meet.

The paver system 10 can also include an edge restraint system 10 around one or more sides of the perimeter of a paver arrangement to further support and anchor the pavers 14. The perimeter of the paver arrangement refers to the collective exterior edges of pavers 14 of a paver arrangement. The edge restraint system 10 can provide additional support and/or limit movement of pavers 14 around the perimeter of the paver arrangement. In some embodiments, the edge restraint system 10 couples the perimeter of the paver arrangement to a wall or other structure adjacent and at least partially surrounding the perimeter of the paver arrangement. For example, the edge restraint system 10 can directly or indirectly couple the perimeter of the paver arrangement to a parapet wall 22 or to the curb of a building's roof structure. A parapet wall or curb 22 is a barrier which is a vertical extension of a roof, terrace, balcony, walkway or other structure, such as a vertical extension of a wall at the edge of such a structure.

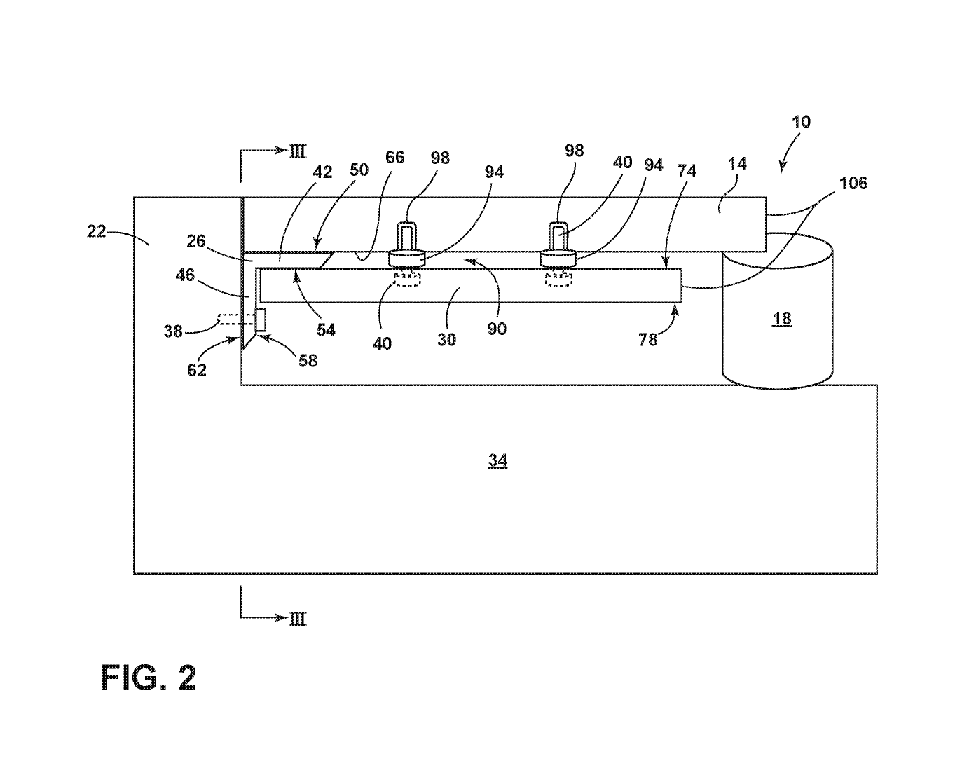

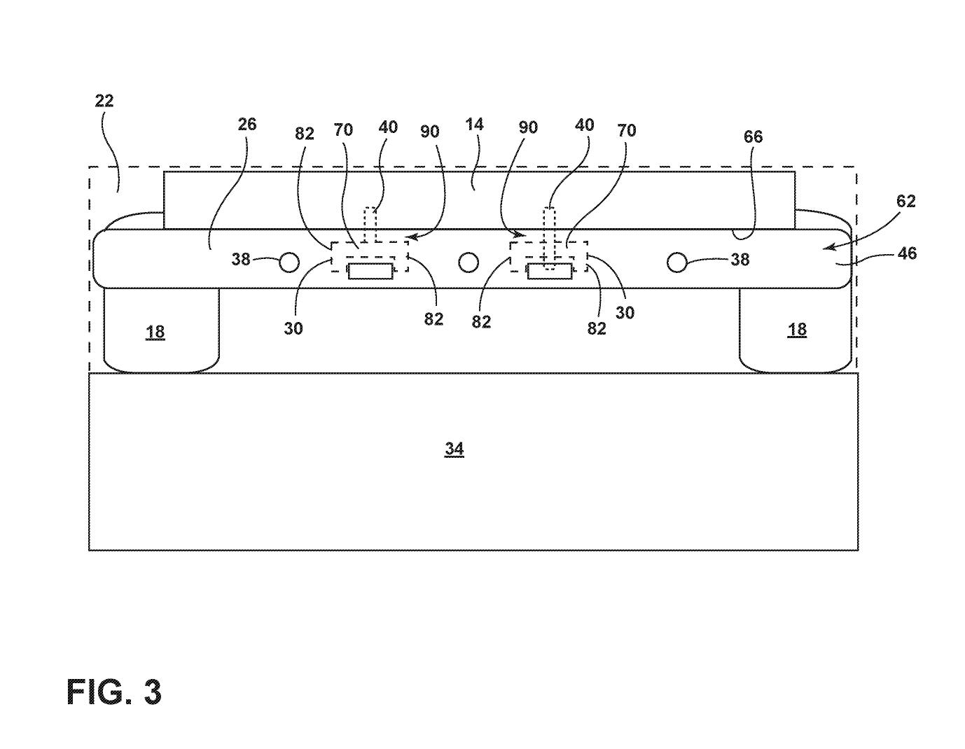

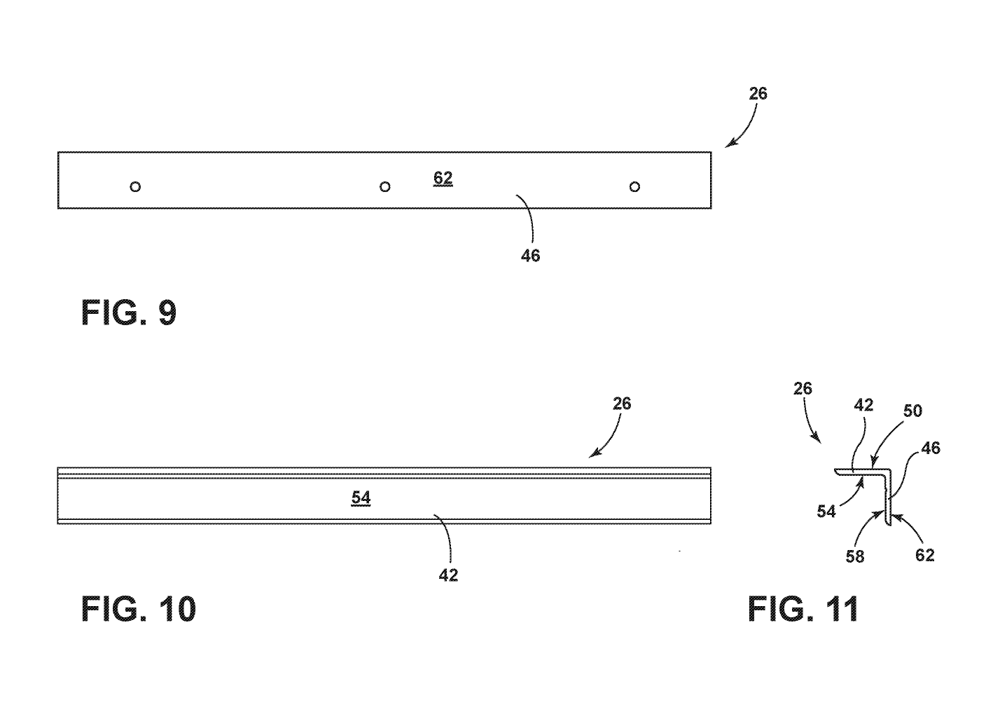

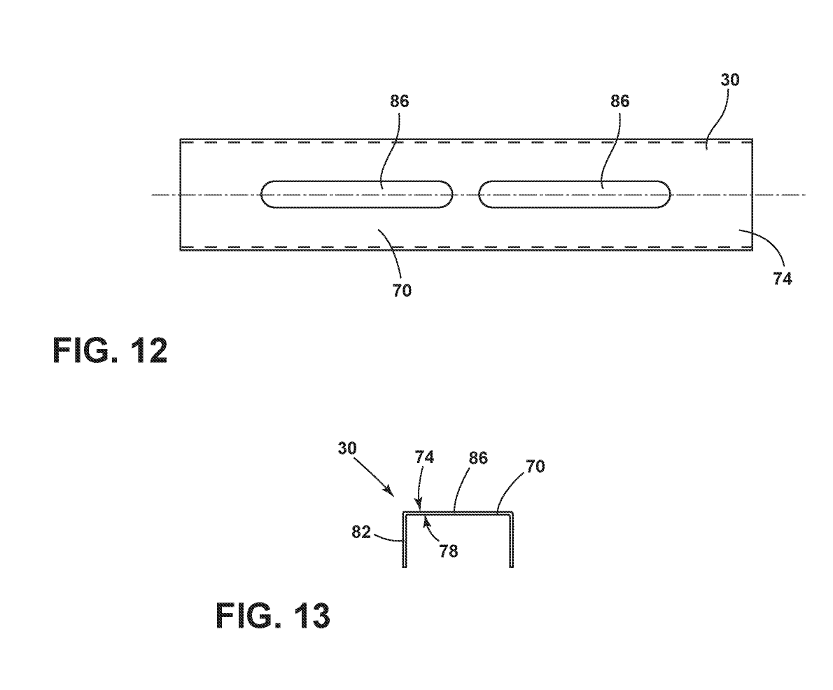

FIGS. 1-5 and 14 illustrate one embodiment of an edge restraint system 10. The edge restraint system 10 includes a support bracket 26 (see also, FIGS. 9-11) and a restraining bracket 30 (see also, FIGS. 12-13). The support bracket 26 supports one or more pavers 14 above a surface, and the restraining bracket 30 limits movement of the paver(s) 14, such as upward movement of the paver(s) 14. In the embodiment illustrated in FIGS. 2 and 3, the support bracket 26 and the restraining bracket 30 are separate elements. As will be described below, in other embodiments the support bracket 26 and the restraining bracket 30 can be integrally formed, or can otherwise define a single element.

The support bracket 26 can support one or more pavers 14 in an elevated position above a roof 34 or other surface. In the illustrated embodiment by way of example, the support bracket 26 is coupled to a parapet wall or curb 22 (hereinafter referred to simply as “wall”) that extends upward from the surface of a roof 34. One or more fasteners 38 can be used to couple the support bracket 26 to the wall 22 at any desired height above the surface of the roof 34. The illustrated support bracket 26 includes a first member 42 extending in a first direction and a second member 46 extending in a second direction that is perpendicular to the first direction. The first member 42 and the second member 46 define an L-shaped bracket. In other embodiments, the support bracket 26 can have other shapes (e.g., U-shaped support brackets, I-shaped brackets, tubing with rectangular, square, or other cross-sectional shapes, and the like) still capable of supporting the edges of one or more pavers 14 while also being secured to the wall 22 with one or more fasteners. With continued reference to the embodiment of FIGS. 1-5 and 14, the first member 42 of the illustrated support bracket 26 is generally parallel to the surface of the roof 34, and the second member 46 is generally parallel to the wall 22. The first member 42 of the support bracket 26 includes a top side 50 and a bottom side 54. As shown in FIG. 2, when the support bracket 26 is supporting a paver 14, the top side 50 of the first member 42 generally faces the paver (e.g., the underside of the paver 14), and in some embodiments is in contact with the paver 14. More specifically, the first member 42 of the support bracket 26 extends outward from the wall 22 to a position beneath at least a portion of the paver 14. Accordingly, the first member 42 supports the bottom surface 66 of the paver 14. The bottom side 54 of the first member 42 can also be in contact with the restraining bracket 30 (described in greater detail below). The second member 46 of the support bracket 26 includes a front side 58 and a back side 62. When the support bracket 26 is coupled to the wall 22, the back side 62 of the second member 46 generally faces the wall 22 and can be in contact with the wall 22.

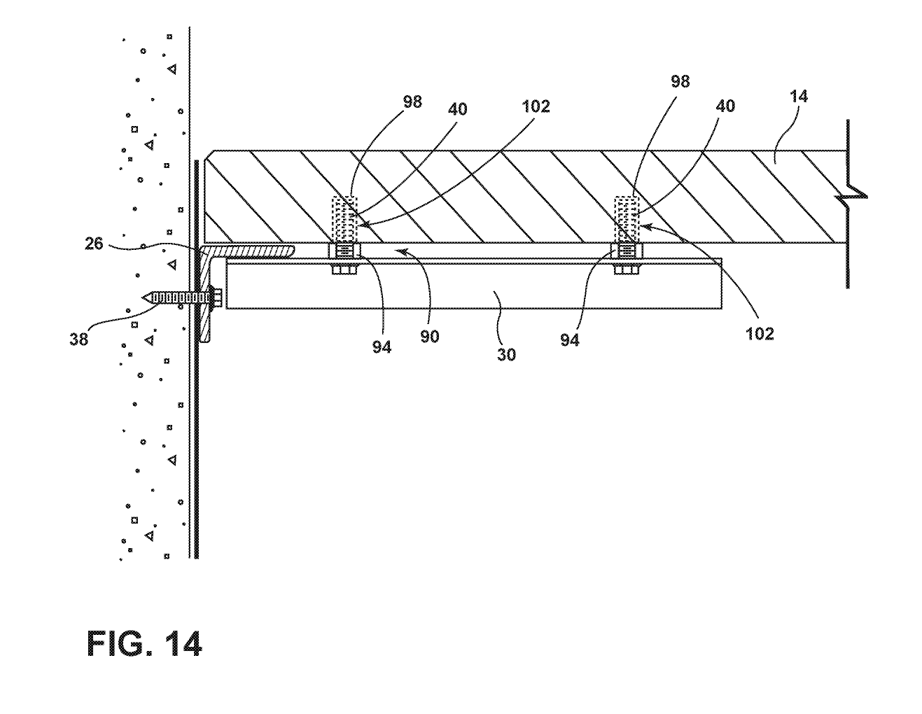

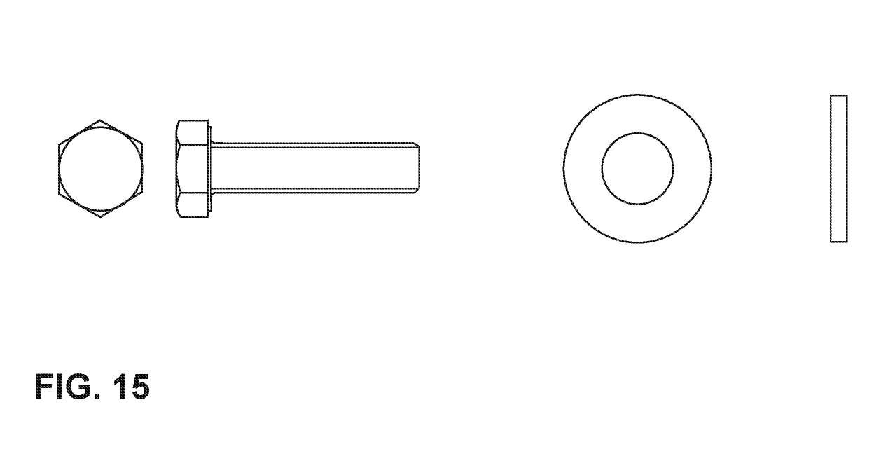

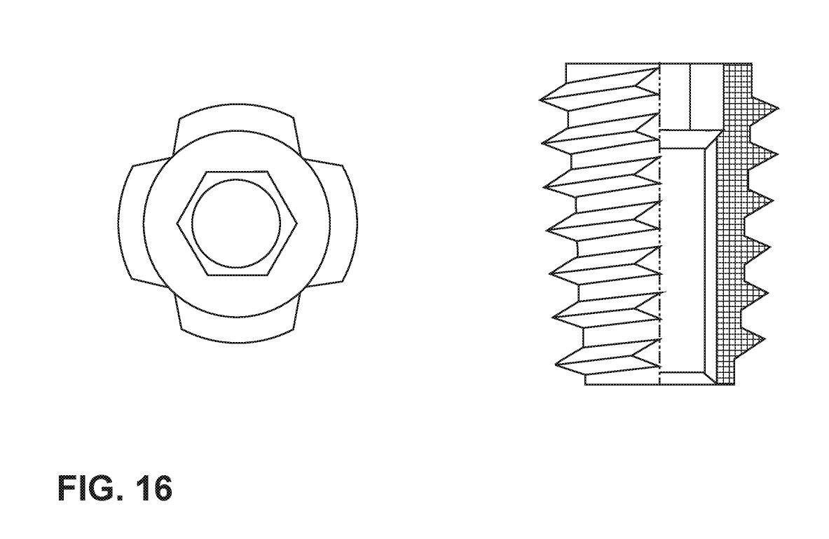

The restraining bracket 30 of the illustrated embodiment is U-shaped (inverted as shown in FIGS. 3 and 14), and includes a planar member 70 having a top side 74 and a bottom side 78. When the edge restraint system 10 is assembled onto one or more pavers 14, the restraining bracket 30 is positioned below the paver 14 such that the planar member 70 extends parallel to the paver(s) 14. Opposing sides 82 extend downward from the bottom side 54 of the planar member 70 to form the U-shape of the illustrated restraining bracket 30, thereby providing a degree of stiffness and strength to the restraining bracket 30. In other embodiments, the restraining bracket 30 does not include sides 82, or can have any other desired orientation, such as being inverted compared to the orientation shown in the illustrated embodiments, rotated 90 degrees (to place one of the sides 82 in facing relationship with the underside of the paver(s) 14, and the like. Also, in other embodiments the restraining bracket 30 can have other shapes suitable for supporting one or more pavers 14 while interacting with the support bracket 26 to restrain vertical movement of the paver 14 as described in greater detail below, such as L-shaped or I-shaped restraining brackets 30, tubular restraining brackets 30 (i.e., having a square, rectangular, or other cross-sectional shape), and the like. With reference again to the illustrated embodiment of FIGS. 1-5 and 14), one or more apertures 86 extends through the planar member 74 of the restraining bracket 30. The apertures 86 are configured to receive one or more fasteners 40 for coupling the restraining bracket 30 to the paver 14. In some embodiments, the apertures 86 can be elongated or otherwise shaped to permit relative movement and adjustment of the restraining bracket 30 with respect to the fastener 40 and paver 14 prior to tightening the fastener 40, thereby allowing the user to adjust the position of the paver 14 so that the fastener 40 can be received within apertures or cavities in the paver 14 and/or so that the position of the paver 14 can be adjusted with respect to the support bracket 26 and wall 22.

In some embodiments the restraining bracket 30 can be coupled to the paver 14 at a distance from the paver 30 so that a space 90 remains between the restraining bracket 30 and the bottom surface 66 of the paver 14. In the illustrated embodiment, spacers 94 are positioned between the top side 74 of the planar restraining bracket 30 and the bottom surface of the paver 14. A fastener 40, such as a threaded fastener (e.g., bolt or screw), can extend through the aperture 86 in the restraining bracket 30, through the spacer 94, and into the paver 14. In other embodiments, the fastener 40 does not extend through the spacer 94, yet the spacer 94 is still located between the restraining bracket 30 and the paver 14 to at least partially define the space 90 described above. Additionally, in some embodiments, an insert 98 is positioned in a cavity 102 of the paver 14 for receiving the fastener 40. For example, threaded inserts 98 can be positioned in one or more cavities 102 of the paver 14 to threadably receive a fastener. The inserts 98 can be internally threaded, externally threaded, both internally and externally threaded, or absent of any threads to both be received within the cavities 102 of the paver 14 and to receive threaded fasteners 40 to secure the restraining bracket 30 to the paver 14. In other embodiments, the fastener 40 extends directly into the paver 14 without the user of an insert 98 (See, e.g., FIG. 3). Also, in some embodiments the restraining bracket 30 is secured to the paver 14 in other manners, such as by the use of adhesive or cohesive bonding material (which can also be used in conjunction with the fasteners 40 and/or inserts 98 described above), by other types of fasteners (e.g., nails, rivets, and the like, depending at least in part upon the material of the pavers 14) by interlocking tabs, clips, or other elements, and the like. The assembly of the restraining bracket 30 and the paver 14 is referred to as the paver assembly 106.

When the edge restraint system 10 is assembled, the restraining bracket 30 engages with the support bracket 26, or is otherwise positioned with respect to the support bracket 26 so that at least a portion of the support bracket 26 interferes with upward movement of at least a portion of the restraining bracket 30. In the illustrated embodiment of FIGS. 1-5 and 14, the top side 74 of the planar member 70 engages with the bottom side 54 of the first member 42, such as in a clamping arrangement where the support bracket 26 is in constant contact with the restraining bracket 30, or only when the restraining bracket 30 is moved in an upward direction. Accordingly, the first member 42 of the support bracket 26 extends into the space 90 between the paver 14 and the restraining bracket 30. This relationship between the support bracket 26 and the restraining bracket 30 limits upward movement of the paver 14, and in some cases (e.g., when the support bracket 26 is clamped between the paver 14 and the restraining bracket 30 rather than being loosely received therebetween) can limit lateral and other movement of the paver 14. For example, the contact of the planar member 70 with the first member 42 of the support bracket 26 prohibits upward movement of the paver 14.

To assemble the edge restraint system 10 according to the embodiment illustrated in FIGS. 1-5 and 14, the support bracket 26 is coupled to the wall 22 and the restraining bracket 30 is coupled to the paver 14. The support bracket 26 is coupled to the wall 22 by one or more fasteners 38 extending through the second member 46 of the support bracket 26. The support bracket 26 can be oriented so that the second member 46 is flush with the wall 22 and with the first member 42 extending outwardly from the wall 22. The first member 42 is positioned to support the paver 14 above the surface of the roof 34.

The restraining bracket 30 can be coupled to the paver 14 in a number of different ways, as described above, so that as space 90 is defined between the restraining bracket 30 and the paver 14. For example, spacers 94 may be positioned between the paver 14 and the restraining bracket 30 to at least partially define the space 90. The fasteners 40 are then used to couple the restraining bracket 30 to the paver 14. Once the restraining bracket 30 is coupled to the paver 14, the paver assembly 106 can be attached to the support bracket 26. Specifically, the paver assembly 106 is aligned so that the first member 42 of the support bracket 26 is slid into the space 90 between the paver 14 and the restraining bracket 30. A pedestal 18 can be used to support the opposite end of the paver 14.

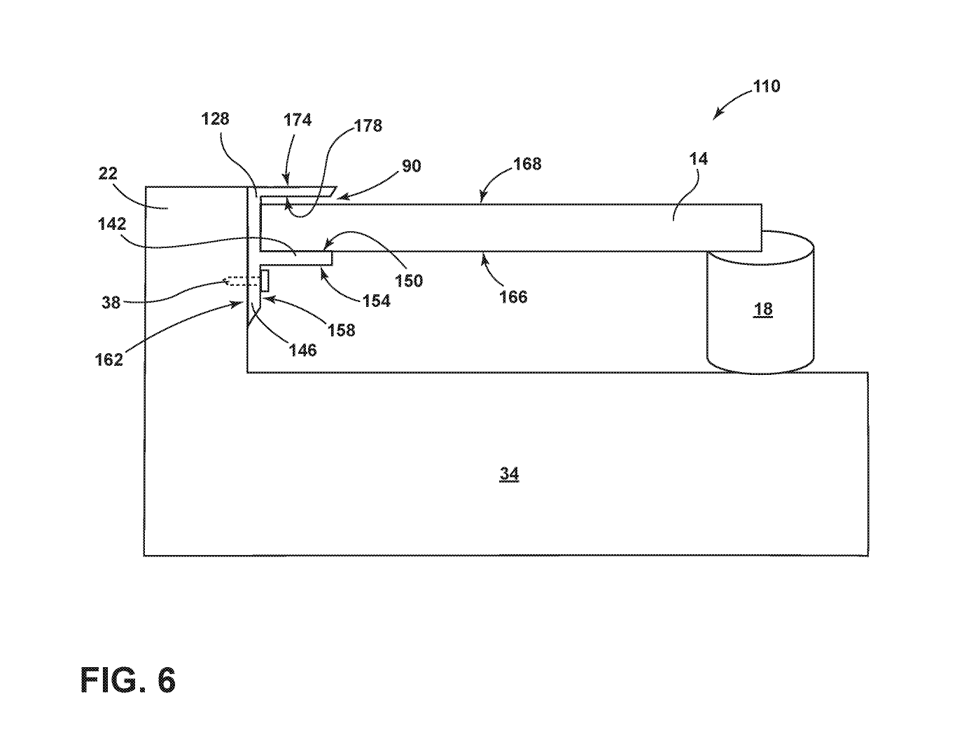

FIGS. 6-8 illustrate other embodiments of an edge restraint system 110. Barring conflict of structure and assembly between the edge restraint systems described above and those illustrated in FIGS. 6-8, details regarding the structure and assembly of the edge restraint systems (and alternatives thereto) described above apply equally to the embodiments of FIGS. 6-8. With reference to FIG. 6, the edge restraint system 110 includes a support and restraining bracket 128. In the illustrated embodiment, the support and restraining bracket 128 is shaped to perform the same or similar functions as the support bracket 26 and restraining bracket 30 described above with reference to the illustrated embodiment of FIGS. 1-5 and 14. In some embodiments, the support and restraining bracket 128 is a single integral element as shown, whereas in other embodiments the support and restraining bracket 128 is constructed of two or more elements (e.g., separately identifiable support and restraining brackets attached together in any suitable manner. The support and restraining bracket 128 includes a first member 142 extending in a first direction, a second member 146 extending in a second direction (e.g., perpendicular to the first direction). The first member 142 and the second member 146 define an L-shaped bracket, with the first member 142 parallel to the surface of the roof 34 and/or the paver 114 and the second member 146 parallel to the wall 22. The first member 142 of the support and restraining bracket 128 includes a top side 150 and a bottom side 154. As shown in FIG. 6, when the support and restraining bracket is supporting a paver 114, the top side 150 of the first member 142 is in contact with the paver 114. More specifically, the first member 142 of the support and restraining bracket extends outward from the wall 22 to a position beneath the paver 114. Accordingly, the first member 142 supports the bottom surface 166 of the paver 114. The second member 146 of the support and restraining bracket includes a front side 158 and a back side 162. When the support and restraining bracket is fastened to the wall 212, the back side 162 of the second member 146 can contact the wall 22. A fastener 138 extends through the second member 146 and into the wall 22 to couple the support and restraining bracket to the wall 22.

The illustrated support and restraining bracket 128 also includes a top member 170 having a top side 174 and a bottom side 158. When the edge restraint system 110 is assembled, the bottom side 178 of the top member 170 extends outwardly from the wall 22 and above a top surface 168 of the paver 114. In other words, the paver 114 is positioned within a space 190 between sides 150, 178 of the support and restraining bracket 128. When the paver 114 fits within the space 90 (whether with a degree of clearance or snugly), in some embodiments no fastener 140 is needed to attach the paver 114 to the edge restraint system 110. However, in other embodiments, a fastener 138 may be used to couple the paver 114 to the edge restraint system 110. For example, one or more apertures (not shown in FIG. 6) may extend through the top member 170 of the support and restraining bracket 128. The apertures can be configured to receive one or more fasteners 140 for attaching the support and restraining bracket 128 to the paver 114.

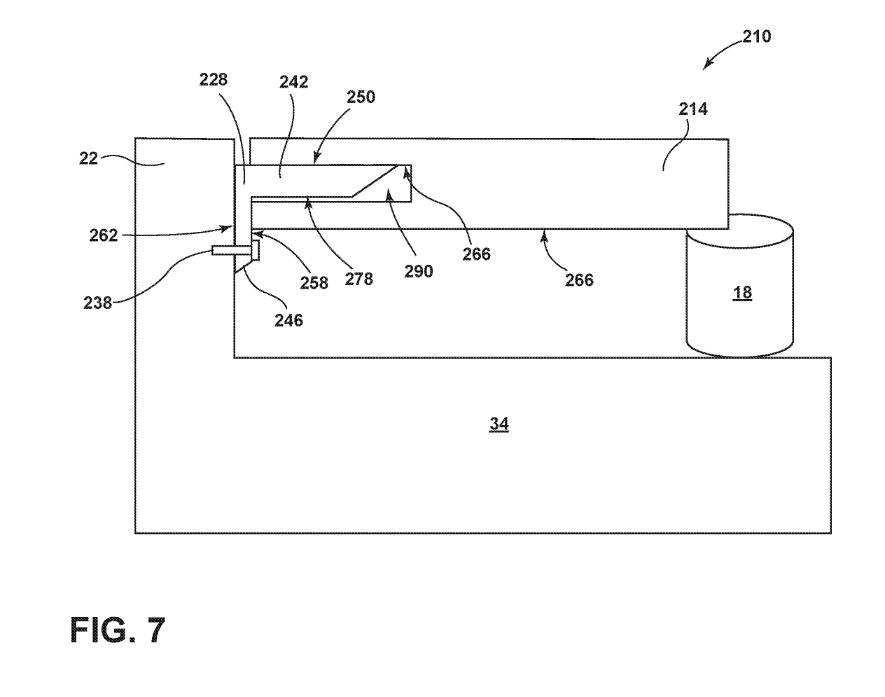

In the embodiment illustrated in FIG. 7, the support and restraining bracket 228 is received within a space 290 defined in the paver 214, such as a groove, slot, or other aperture in an edge of the paver 214. In the illustrated embodiment, the support and restraining bracket 228 includes a first member 242 extending in a first direction and a second member 246 extending in a second direction (e.g., perpendicular to the first direction). The first member 242 and the second member 246 define an L-shaped bracket, with the first member 242 parallel to the surface of the roof 34 and/or the paver 114 and the second member 246 parallel to the wall 22. The first member 242 of the support and restraining bracket 228 extends outward from the wall 22 and into the space 290 defined by the paver 214. More specifically, the first member 242 of the support and restraining bracket 228 includes a top side 250 that supports a bottom-facing surface 266 of the paver 214. The second member 246 of the support and restraining bracket 228 includes a front side 258 and a back side 262. When the support and restraining bracket 228 is fastened to the wall 22, the back side 262 of the second member 246 can contact the wall 22. A fastener 238 extends through the second member 246 and into the wall 22 to couple the support and restraining bracket 228 to the wall 22.

With continued reference to FIG. 7, the support and restraining bracket 228 extends downward from the first member 242. The support and restraining bracket 228 also includes a planar member 270 with a bottom side 278. The bottom side 278 of the planar member 270 extends over an upwardly-facing surface 266 of the paver 214. With this configuration, the support and restraining bracket 228 prevents or at least limits upward movement of the paver 214.

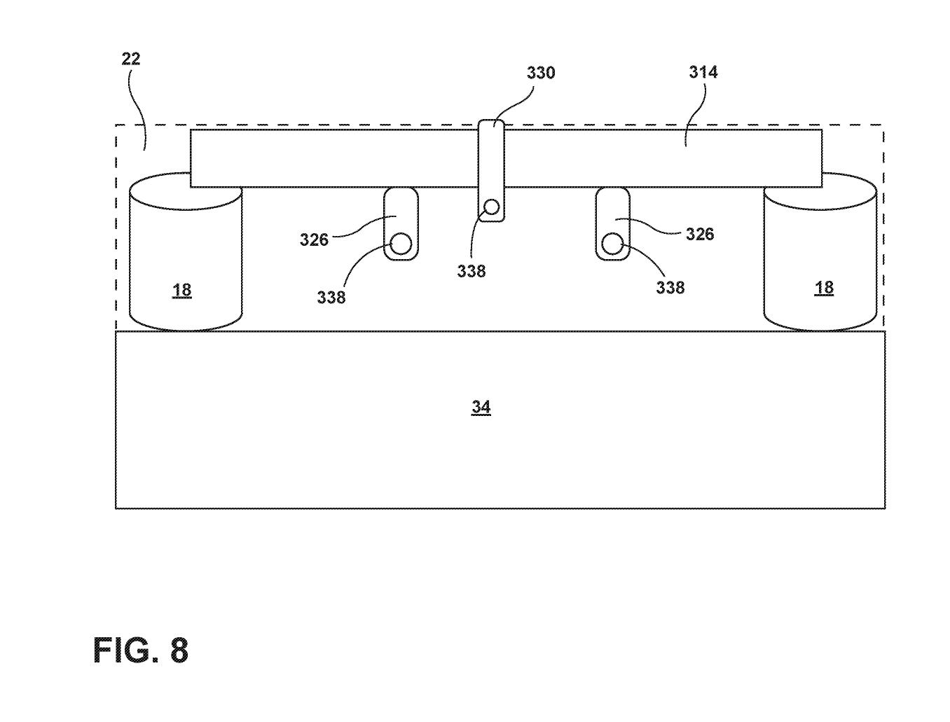

With reference to FIG. 8, the illustrated edge restraint system 310 (shown viewed from the wall 22) can include at least one support bracket 326 and at least one restraining bracket 330 that are separate elements each attached to the wall (not shown) by respective fasteners 338. The illustrated support bracket 326 and restraining bracket 330 are separate elements that can be laterally spaced apart from one another as shown while still supporting the paver 314 and preventing or at least limiting (i.e., restricting) upward movement of the paver 314. The support bracket 326 supports the paver 314 above the surface of the roof 34, and the restraining bracket 330 restricts upward movement of the paver 314.

The embodiment described above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention.

Various features and advantages of the invention are set forth in the following claims.

1. A paver edge restraint system for supporting a paver adjacent to an upstanding wall, the paver having a top surface and a bottom surface, the paver edge restraint system comprising:
a support bracket including a first member extending in a first direction and a second member extending in a second direction, the first direction being parallel to the bottom surface of the paver, the second direction being parallel to the upstanding wall, the first member configured to support the paver, the second member configured to be coupled to the upstanding wall; and
a restraining bracket extending beneath the paver and positioned to limit upward movement of the paver.

2. The paver edge restraint system of claim 1, wherein the support bracket and the restraining bracket are separate elements.

3. The paver edge restraint system of claim 1, wherein the first member and the second member define an L-shaped bracket.

4. The paver edge restraint system of claim 1, wherein the restraining bracket is coupled to the paver to define a space between a top side of the restraining bracket and the bottom surface of the paver.

5. The paver edge restraint system of claim 4, further comprising a spacer positioned within the space between the top side of the restraining bracket and the bottom surface of the paver to maintain the space between the restraining bracket and the paver.

6. The paver edge restraint system of claim 4, wherein the first member of the support bracket extends within the space between the top side of the restraining bracket and the bottom surface of the paver.

7. The paver edge restraint system of claim 1, wherein the restraining bracket includes a plurality of apertures configured to received one or more fasteners, and wherein the apertures are elongated to permit movement of restraining bracket with respect to the fastener.

8. The paver edge restraint system of claim 1, wherein the first member of the support bracket includes a top side that is oriented to face the bottom side of the paver, and wherein the second member of the support bracket includes a bottom side that is oriented to face a top side of the restraining bracket.

9. The paver edge restraint system of claim 1, wherein the restraining bracket is U-shaped.

10. The paver edge restraint system of claim 1, wherein the restraining bracket includes a planar member that extends parallel to the bottom surface of the paver.

11. A paver edge restraint system for securing a paver in an elevated position adjacent a wall and with respect to a surface beneath the paver, the paver supported upon the surface by at least one pedestal disposed a distance from the wall, the paver edge restraint system comprising:
a support bracket configured to be mounted to a side of the wall, the support bracket having an elongated horizontal surface extending from the wall and positioned to support an edge of the paver adjacent the wall;
a restraining bracket; and
at least one fastener positioned to mount the restraining bracket to an underside of the paver;
wherein a portion of the support bracket is positioned to extend over a portion of the restraining bracket to restrict vertical movement of the restraining bracket and the paver thereon.

12. The paver of claim 11, wherein the fastener is configured to mount the restraining bracket to the paver at a distance such that a space is disposed between a top side of the restraining bracket and the bottom surface of the paver.

13. The paver of claim 12, wherein the horizontal surface of the support bracket extends within the space between the top side of the restraining bracket and the bottom surface of the paver.

14. The paver of claim 11, further comprising a spacer positioned within the space between the top side of the restraining bracket and the bottom surface of the paver to maintain the space between the restraining bracket and the paver.

15. The paver edge restraint system of claim 11, wherein the support bracket and the restraining bracket are separate elements.

16. A method of securing a paver in elevated position with respect to an underlying surface and an adjacent wall, the method comprising:
orienting a support bracket in a substantially horizontal orientation against the side of the wall at an elevation above the underlying surface;
mounting the support bracket to the side of the wall in the substantially horizontal orientation and at the elevation;
mounting a restraining bracket to an underside of the paver;
positioning a first edge of the paver on a pedestal located a distance from the wall;
positioning a second edge of the paver on a portion of the support bracket extending away from the wall;
supporting the first edge of the paver upon the pedestal;
supporting the second edge of the paver upon the portion of the support bracket so that the paver is elevated over the surface;
restricting upward movement of the restraining bracket with the support bracket; and
restricting upward movement of the paver by restricting upward movement of the restraining bracket.

17. The method of claim 16, wherein mounting a restraining bracket to an underside of the paver includes mounting the restraining bracket at a distance to the paver such that a space is disposed between a top side of the restraining bracket and the underside of the paver.

18. The method of claim 17, further including positioning the support bracket within the space, and wherein restricting upward movement of the restraining bracket with the support bracket includes orienting the paver and the restraining bracket such that the paver is above the support bracket and the restraining bracket is below the support bracket when the support bracket is positioned within the space.

19. The method of claim 17, wherein mounting the restraining bracket at a distance includes positioning spacers between the restraining bracket and the paver to maintain the space between the restraining bracket and the paver.

20. The method of claim 16, wherein restricting upward movement of the restraining bracket with the support bracket includes forming the support bracket and the restraining bracket as a single integral element such that the restraining bracket cannot move relative to the support bracket.
